(19) United States
(12) Patent Application Publication
(10) Pub. No.: US 2013/0215156 A1
(43) Pub. Date: Aug. 22, 2013

(54) PORTABLE PROJECTOR DEVICE, AND METHOD OF PROLONGING BATTERY LIFE OF A BATTERY OF THE SAME AND OPTIMIZING QUALITY OF AN IMAGE PROJECTED BY THE SAME

(71) Applicants: CHE-TING LI, TAIPEI (TW); KUNG-HUAN CHAN, TAIPEI (TW); HSI-PIN LI, TAIPEI (TW)

(72) Inventors: CHE-TING LI, TAIPEI (TW); KUNG-HUAN CHAN, TAIPEI (TW); HSI-PIN LI, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/611,073

(22) Filed: Sep. 12, 2012

(30) Foreign Application Priority Data
Feb. 22, 2012 (CN) 201210046945.8

(51) Int. Cl. G09G 5/10

(52) U.S. Cl. 345/690

(57) ABSTRACT

A portable projector device includes an image processing unit, an optical mechanical system, a light source controller, and a power supply management unit. The power supply management unit is to be coupled to a battery, which powers up the portable projector, is for detecting a residual capacity of the battery, and is operable according to the residual capacity of the battery to enable the light source controller to adjust illumination of a light source of the optical mechanical system and to enable the image processing unit to process an input image signal according to a display parameter so as to optimize the image projected by the image projecting unit.

### CROSS-REFERENCE TO RELATED APPLICATION

This application claims priority of Chinese Patent application no. 201210046945.8, filed on Feb. 22, 2012.

### BACKGROUND OF THE INVENTION

1. Field of the Invention

This invention relates to a portable projector device, more particularly to a portable projector device to be powered up by a battery, and a method of prolonging battery life of the battery of the portable projector device and optimizing quality of an image projected by the portable projector device.

2. Description of the Related Art

Conventional portable projector devices are usually powered up by batteries to provide portability thereof. It is desirable for a user to have a portable projector device that can provide high illumination as well as a relatively long battery life. However, it is incompatible to have both high illumination and a relatively long battery life in the conventional portable projector device.

Additionally, cutoff voltage of a battery may change according to a discharge current of the battery. As shown in Table 1 below, for example, when a discharge current of a battery is smaller than 0.2 C (520 mA, 1 C is equal to 2600 mA), 100 percent capacity of the battery can be discharged. However, when a discharge current of the battery is larger than 1 C, for example, equal to 2 C, 80 percent capacity of the battery can be discharged, leaving 20 percent capacity of the battery unused.

TABLE 1

| | DISCHARGE CONDITION | | | |
|---|---|---|---|---|
| DISCHARGE | 0.2 C | 0.5 C | 1.0 C | 2.0 C |
| CURRENT | (520 mA) | (1300 mA) | (2600 mA) | (5200 mA) |
| CAPACITY | 100% | 95% | 90% | 80% |

The conventional portable projector device will be automatically shut down when the cutoff voltage of the battery has been reached. Consequently, when the discharge current is relatively large (i.e., the portable projector device provides high illumination), the conventional portable projector device is shut down prior to complete discharge of the battery, such that the battery life of the battery is decreased as compared to a discharge condition, with a relatively small discharge current (i.e., the portable projector device provides low illumination).

Furthermore, display parameters such as a dynamic contrast parameter and a gamma value for an image projected by the conventional portable projector device will not be adjusted automatically when illumination of the conventional portable projector device is decreased, resulting in inferior quality of the image projected by the conventional portable projector device.

### SUMMARY OF THE INVENTION

Therefore, an object of the present invention is to provide a portable projector device to be powered up by a battery, and a method of prolonging battery life of the battery of the portable projector device and optimising quality of an image projected by the portable projector device.

According to an aspect of this invention, a portable projector device to be powered up by a battery comprises an image input terminal, an image processing unit, an optical mechanical system, a light source controller, and a power supply management. The image input terminal is for receiving an input image signal. The image processing unit is coupled to the image input terminal for receiving the input image signal therefrom, and is operable to process and convert the input image signal according to a display parameter so as to output an output image signal. The optical mechanical system includes a light source, and an image projecting unit coupled to the image processing unit for receiving the output image signal and operable according to the output image signal to modulate the light source so as to project an image. The light source controller is coupled to the light source of the optical mechanical system for controlling a power supplied to the light source so as to adjust illumination of the light source. The power supply management unit is to be coupled to the battery for detecting a residual capacity of the battery, and is operable to enable the light source controller to adjust the power supplied to the light source according to the residual capacity of the battery and to enable the image processing unit to process the input image signal according to a display parameter related to the residual capacity of the battery so as to optimize the image projected by the image projecting unit.

According to another aspect of this invention, a method of prolonging battery life of a battery of a portable projector device and optimising quality of an image projected by the portable projector device is to be implemented by the portable projector device. The portable projector device includes an image processing unit for processing and converting an input image signal according to a display parameter so as to output an output image signal, an optical mechanical system including a light source and an image projecting unit for modulating the light source so as to project an image according to the output image signal, a light source controller for controlling a power supplied to the light source, and a power supply management unit. The method comprises the following steps of: configuring the power supply management unit to detect a residual capacity of the battery; and configuring the power supply management unit to enable the light source controller to adjust the power supplied to the light source according to the residual capacity of the battery, and to enable the image processing unit to process the input image signal according to a display parameter related to the residual capacity of the battery so as to optimise the quality of the image projected by the image projecting unit.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a preferred embodiment of a portable projector device to be powered up by a battery according to the present invention;

FIG. 2 is a flow chart of a preferred embodiment of a method of prolonging battery life of a battery of a portable projector device and optimising quality of an image projected by the portable projector device according to the present invention; and

FIG. 3 is a flow chart of a modification of the preferred embodiment of the method of prolonging battery life of the battery of the portable projector device and optimizing quality of the image projected by the portable projector device.

### DETAILED DESCRIPTION OF THE PREFERRED EMBODIMENT

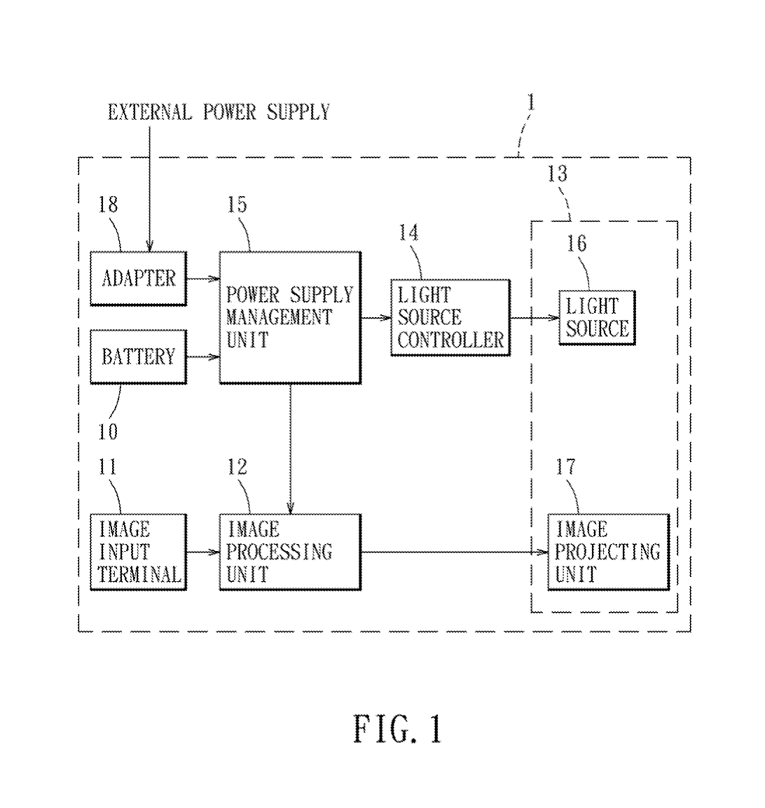

Referring to FIG. 1, a block diagram of a preferred embodiment of the portable projector device 1 to be powered up by a battery 10 according to the present invention is shown. The portable projector device 1 includes an image input terminal 11, an image processing unit 12, an optical mechanical system 13, a light source controller 14, and a power supply management unit 15. It is noted that the portable projector device 1 may be a standalone device or integrated with a smart phone.

The image input terminal 11 is for receiving an input image signal. The image processing unit 12 is coupled to the image input terminal 11 for receiving the input image signal therefrom, and is operable to process the input image signal, e.g. scaling and time sequence conversion, and to convert the input image signal according to a display parameter, e.g. brightness, dynamic contrast, saturation and gamma value, so as to output an output image signal.

The optical mechanical system 13 includes a light source 16, and an image projecting unit 17 coupled to the image processing unit 12 for receiving the output image signal and operable according to the output image signal to modulate the light source 16 so as to project an image. The light source controller 14 is coupled to the light source 16 of the optical mechanical system 13 for controlling a power supplied to the light source 16 so as to adjust illumination of the light source 16. It is noted that the image projecting unit 17 includes one of a digital micromirror device (DMD) chip and a liquid crystal on silicon (LCoS) chip and the light source 16 is an LED light source or a semiconductor laser diode light source.

The battery 10 can be a primary battery or at rechargeable battery. The portable projector device 1 further includes an adapter 18 electrically coupled to the power supply management unit 13, and adapted to be coupled to an external power source such as a power seeker (not shown), for converting an input voltage from the external power source into electrical energy that is to be supplied to the portable projector device 1. When it is detected by the power supply management unit 15 that the adapter 18 is coupled to the external power source, the portable projector device 1 is powered up by the electrical energy supplied therefrom, and the battery 10 may be charged if the battery 10 is a rechargeable battery. On the other hand, the components of the portable projector device 1 (such as the image processing unit 12, the optical mechanical system 13, the light source controller 14, and the image projecting unit 17) are driven by electrical energy from the battery 10 when it is detected that the adapter 18 is not coupled to the power socket.

Therefore, it is an object of the invention to prolong battery life of the battery 10 of the portable projector device 1 and to optimize quality of the image projected by the portable projector device 1 while the battery 10 serves as a power supply for the portable projector device 1.

The power supply management unit 15 is to be coupled to the battery 10 for detecting a residual capacity of the battery 10, and is operable to enable the light source controller 14 to adjust the power supplied to the light source 16 according to the residual capacity of the battery 10 and to enable the image processing unit 12 to process the input image signal according to a display parameter related to the residual capacity of the battery 10 so as to optimize the image projected by the image projecting unit 17.

More specifically, the power supply management unit 15 stores a lookup table (see Table 2 below) having a plurality of parameter sets. Each of the parameter sets includes a threshold voltage value (Vₜₕₙ), a light source power value (Pₙ), and a display parameter (Dₙ). The parameter sets are arranged in the lookup table in a descending order with respect to the respective threshold voltage values (Vₜₕₙ). It is noted that the display parameter of each of the parameter sets in the lookup table is one of a dynamic contrast parameter and a gamma value.

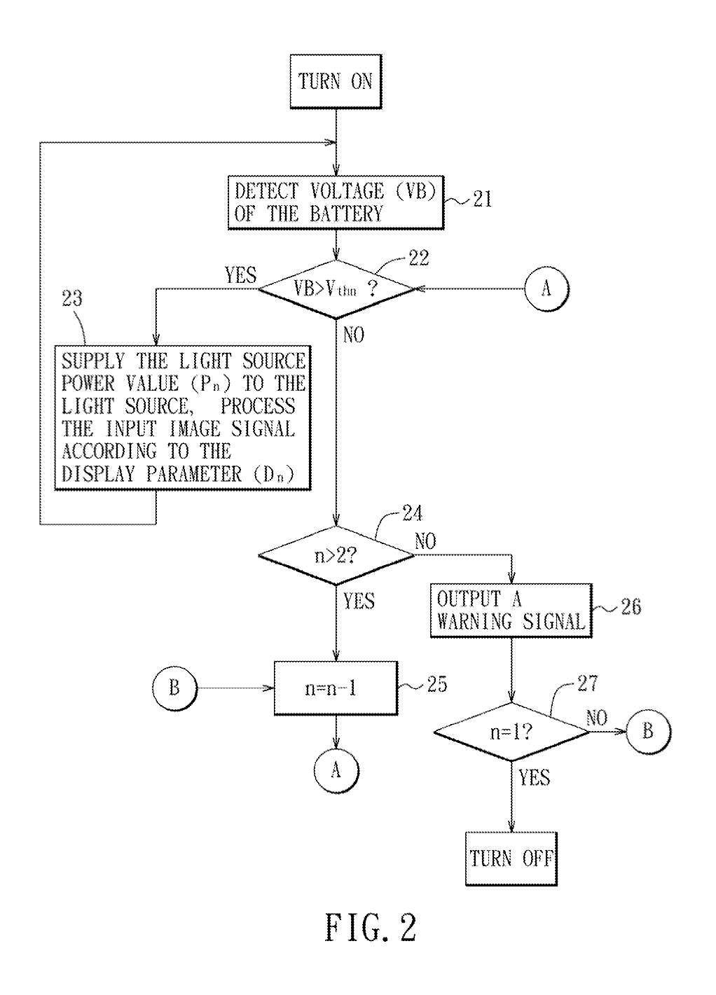

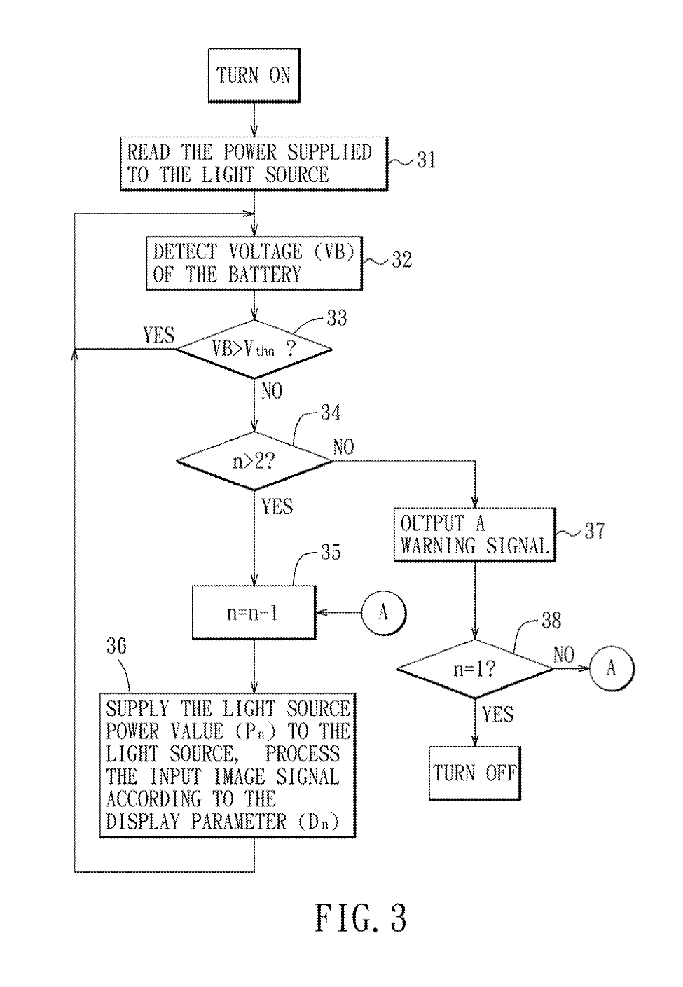

Referring to FIGS. 2 and 3, the portable projector device 1 is configured to implement a preferred embodiment of a method of prolonging battery life of the battery 10 of the portable projector device 1 and optimizing quality of the image projected by the portable projector device 1 according to the present invention.

TABLE 2

| THRESHOLD | LIGHT SOURCE | DISPLAY |
|---|---|---|
| VOLTAGE | POWER VALUE | PARAMETER |
| Vₜₕₙ | Pₙ | Dₙ |
| Vₜₕₙ₋₁ | Pₙ₋₁ | Dₙ₋₁ |
| . | . | . |
| . | . | . |
| . | . | . |
| V₄ | P₄ | D₄ |
| V₃ | P₃ | D₃ |
| V₂ | P₂ | D₂ |
| V₁ | P₁ | D₁ |

As shown in FIG. 2, after the portable projector device 1 is turned on, the portable projector device 1 is configured to implement the preferred embodiment of the method of the present invention.

In step 21, the power supply management unit 15 of the portable projector device 1 is configured to detect the voltage (VB) of the battery 10 as the residual capacity of the battery 10. In step 22, the power supply management unit 15 is configured to compare the voltage (VB) of the battery 10 detected thereby to the threshold voltage values (Vₜₕₙ) one by one in the descending order in the lookup table. The power supply management unit 15 is configured to determine whether the voltage (VB) of the battery 10 is greater than one of the threshold voltage values (Vₜₕₙ) that is approximate or closet to the voltage of the battery 10 (VB).

When it is determined that the voltage (VB) of the battery 10 is greater than said one of the threshold voltage values (Vₜₕₙ) determined in step 22, the power supply management unit 15 is configured, in step 23, to search the lookup table, to control the light source controller 14 to supply the light source 16 with the power as the light source power value (Pₙ) of a corresponding one of the parameter sets that includes the said one of the threshold voltage values (Vₜₕₙ), and to control the image processing unit 17 to process the input image signal according to the display parameter (Dₙ) of the corresponding one of the parameter sets. Said one of the threshold voltage values (Vₜₕₙ) thus serves as an applied one of the threshold voltage values (Vₜₕₙ).

When it is determined that the voltage (VB) of the battery 10 detected by the power supply management unit 15 is smaller than the said one of the threshold voltage values (Vₜₕₙ), the flow goes to step 24.

In step 24, the power supply management unit 15 is configured to determine whether the applied one of the threshold voltage values (Vₜₕₙ) is greater than a critical one of the threshold voltage values (Vₜₕ₃) of the lookup table in the descending order, e.g., n>2 in this embodiment. When the applied one of the threshold voltage values (Vₜₕₙ) is greater than the critical one of the threshold voltage values (Vₜₕ₃), the power supply management unit 15 is configured, in step 25, to search the lookup table, to read out a threshold value (Vₜₕₙ₋₁) of a next one of the parameter sets that is next to a current one of the parameter sets which includes the applied one of the threshold voltage values (Vₜₕₙ). The power supply management unit 15 is further configured to control the light source controller 14 to supply the light source 16 with the power as the light source power value (Pₙ₋₁) of the next one of the parameter sets, and control the image processing unit 17 to process the input image signal according to the display parameter (Dₙ₋₁) of the next one of the parameter sets.

The threshold voltage value (Vₜₕₙ₋₁) of the next one of the parameter sets thus serves as a new applied one of the threshold voltage values (Vₜₕₙ). By this way, the power supplied to the light source 16 by the light source controller 14, i.e., the light source power value (Pₙ), is decreased as well as raising the display parameter (Dₙ), e.g., the dynamic: contrast parameter, for the image processing unit 12 according to the residual capacity, i.e., the voltage (VB), of the battery 10. Consequently, the battery life of the battery 10 of the portable projector device 1 is prolonged and the image projected by the image projecting unit 17 is optimised. Subsequently, the flow goes back to step 22.

When it is determined in step 24 that the applied one of the threshold voltage value (Vₜₕₙ) is not greater than the critical one of the threshold voltage values (Vₜₕ₃), the flow goes to step 2G.

In step 26, the power supply management unit 15 is configured to output a warning signal.

In step 27, the power supply management unit 15 is configured to turn off the portable projector device 1 if the applied one of the threshold voltage values is the last one of the threshold voltage values (Vₜₕ₁) in the descending order in the lookup table, that is to say, if the battery 10 is about to be exhausted. Further, the flow goes to step 25 if the applied one of the threshold voltage values is not the last one of the threshold voltage values, i.e., n=2.

Additionally, it should be noted that the lookup table stored in the power supply management unit 15 may be omitted in other embodiments of this invention, and that only the threshold voltage values (Vₜₕ₁, Vₜₕ₂, . . . , Vₜₕₙ) arranged in the descending order are stored in the power supply management unit 15. Accordingly, when it is detected by the power supply management unit 15 that the voltage (VB) of the battery 10 is smaller than the applied one of the threshold voltage values (Vₜₕₙ) that is, and is larger than the critical one of the threshold voltage values (Vₜₕ₃), the power supply management unit 15 is configured to enable the light source controller 14 to decrease the power supplied to the light source 16 by a predetermined amount according to the voltage (VB) of the battery 10, to adjust the display parameter according to the predetermined amount, and to apply a next one of the threshold voltage values (Vₜₕₙ), this process is repeated until the applied one of the threshold voltage values (Vₜₕₙ) is the not greater than a critical one of the threshold voltage values (Vₜₕ₂) in the descending order. The power supply management unit 15 is then configured to output the warning signal when the voltage of the battery (VB) is net greater than the critical one of the threshold voltage values (Vₜₕ₂) in the descending order, and to turn off the portable projector device 1 if the voltage (VB) of the battery 10 is smaller than the not greater than the last one of the threshold voltage values (Vₜₕ₁) in the descending order.

Referring to FIG. 3, a modification of the preferred embodiment of the method of prolonging battery life of the battery 10 of the portable projector device 1 and optimizing quality of the image projected by the portable projector device 1 according to the present invention is shown. After the portable projector device 1 is turned on, the portable projector device 1 is configured to implement the modified preferred embodiment of the method as follows.

In step 31, the power supply management unit 15 of the portable projector device 1 is configured to read the power supplied to the light source 16 from the light source controller 14. It is noted that the power supplied to the light source 16 may not be the light source power value (Pₙ) corresponding to a highest threshold voltage value (Vₜₕₙ) in the lookup table, and may be a light source power value of one of the parameter sets that includes a threshold voltage value which is approximate or closet to the voltage (VB) of the battery 10 at the time the portable projector device 1 was last shut down. The power supply management unit 15 of the portable projector device 1 is further configured to search the lookup table to obtain a reference one of the threshold voltage values (Vₜₕ) that belongs to a current one of the parameter sets which includes the light source power value corresponding to the power supplied to the light source 14.

In the following description, for the purpose of illustration, a light source power value read by the power supply management unit 15 corresponds to the fifth to the last one of the light source power values (P₅) in the lookup table. The power supply management unit 15 is configured to search the lookup table to obtain the reference one of the threshold voltage values (Vₜₕ₅) that belongs to the current one of the parameter sets which includes the light source power value (P₅).

Afterwards, in step 32, the power supply management unit 15 is configured to detect the voltage (VB) of the battery 10. In step 33, the power supply management unit 15 is configured to determine whether the voltage (VB) of the battery 10 is smaller than the reference one of the threshold voltage values (Vₜₕ₅). When it is determined that the voltage (VB) of the battery 10 is greater than the reference one of the threshold voltage values (Vₜₙ₅), the portable projector device 15 is configured to repeat steps 32 to 35.

When it is determined that the voltage (VB) of the battery 10 is smaller than the reference one of the threshold voltage values (Vₜₕ₅), the power supply management unit 15 is configured, in step 34, to determine whether the reference one of the threshold voltage values is greater than a critical one of the threshold voltage values, e.g., n>2 in this embodiment. The flow goes to step 35 when the determination made in step 34 is affirmative, and goes to step 37 when otherwise.

In step 35, the power supply management unit 15 is configured to search the lookup table to find the light source power value (P₄) and the display parameter (D₄) of a next one of the parameter sets that is next to the current one of the parameter sets that includes the reference one of the threshold voltage values (Vₜₕ₅), i.e., n=n−1. In step 36, the power supply management unit 15 is configured to control the light source controller 14 to supply the light source 16 with the power as the light source power value (P₄), and to control the image processing unit 12 to process the input image signal according to the display parameter (D₄). Then, the flow goes back to step 32 with the nest one of the parameter sets serving as the current one of the parameter sets (i.e., n=n−1), and with the threshold voltage value (Vₜₕ₄) of the next one of the parameter sets serving as the reference one of the threshold voltage values to be compared with the voltage (VB) of the batter 10 in step 33. By this way, the power supplied to the light source 16 by the light source controller 14 is decreased and the display parameter (Dₙ) for the image processing unit 12 is adjusted according to the voltage (VB) of the battery 10, such that the image projected by the image projecting unit 17 is optimized while the illumination of the light source 16 is decreased.

In step 37, the power supply management unit 15 is configured to output a warning signal if the reference cue of the threshold voltage values is not greater than the critical one of the threshold voltage values (Vₜₕ₂) in the descending order in the lookup table.

In step 38, the power supply management unit 15 is configured to turn off the portable projector device 1 when the reference one of the threshold voltage values is the last one of the threshold voltage values (Vₜₕ₁) in the descending order in the lookup table, and to implement step 35 when otherwise.

To sum up, in the present invention, by detecting the voltage, i.e., the residual capacity, of the battery 10 of the portable projecting device 1, the power supplied to the light source 16 as well as illumination of the light source 16 is adjusted accordingly, such that the battery life of the battery 10 can be prolonged. At the same time, the display parameter for the image processing unit 12 to process the input image signal is adjusted according to the illumination of the light source 16, thereby optimizing the image projected by the image projecting unit 17.

While the present invention has been described in connection with what is considered the most practical and preferred embodiment, it is understood that this invention, is not limited to the disclosed embodiment but is intended to cover various arrangements included within the spirit and scope of the broadest interpretation so as to encompass all such modifications and equivalent arrangements.

What is claimed is:

1. A portable projector device to be powered up by a battery, said portable projector device comprising:
an image input terminal for receiving an input image signal;
an image processing unit coupled to said image input terminal for receiving the input image signal therefrom, and being operable to process and convert the input image signal according to a display parameter so as to output an output image signal;
an optical mechanical system including a light source, and an image projecting unit coupled to said image processing unit for receiving the output image signal and operable according to the output image signal to modulate said light source so as to project an image;
a light source controller coupled to said light source of said optical mechanical system for controlling a power supplied to said light source so as to adjust illumination of said light source; and
a power supply management unit to be coupled to the battery for detecting a residual capacity of the battery, and operable to enable said light source controller to adjust the power supplied, to said light source according to the residual capacity of the battery and to enable said image processing unit to process the input image signal according to a display parameter related to the residual capacity of the battery so as to optimize the image projected by said image projecting unit.

2. The portable projector device as claimed in claim 1, wherein said power supply management unit stores a lookup table having a plurality of parameter sets, each of which includes a threshold voltage value, a light source power value, and a display parameter, the parameter sets being arranged in the lookup table in a descending order with respect to the respective threshold voltage values,
said power supply management unit being operable to detect a voltage of the battery as the residual capacity of the battery, to compare the voltage of the battery to the threshold voltage values in the descending order in the lookup table, and to determine whether the voltage of the battery is greater than one of the threshold voltage values that is approximate to the voltage of the battery,
when the voltage of the battery is greater than the said one of the threshold voltage values, said power supply management unit being operable to search the lookup table, to control said light source controller to supply said light source with the power as the light source power value of a corresponding one of the parameter sets that includes said one of the threshold voltage values, and to control said image processing unit to process the input image signal according to the display parameter of the corresponding one of the parameter sets;
said one of the threshold voltage values serving as an applied one of the threshold voltage values.

3. The portable projector device as claimed in claim 2, wherein, when it is determined that the voltage of the battery detected by said power supply management unit is smaller than the applied one of the threshold voltage values, said power supply management unit is operable to output a warning signal if the applied one of the threshold voltage values is not greater than a critical one of the threshold values in the descending order in the lookup table, and to turn off said portable projector device if the applied one of the threshold voltage values is the last one of she threshold voltage values in the descending order in the lookup table.

4. The portable projector device as claimed in claim 2, wherein the display parameter of each of the parameter sets in the lookup table is one of a dynamic contrast parameter and a gamma value.

5. The portable projector device as claimed in claim 1, wherein, said power supply management unit stores a lookup table having a plurality of parameter sets each of which includes a threshold voltage value, a light source power value, and a display parameter, the parameter sets being arranged in the lookup table in a descending order with respect to the respective threshold voltage values,
said power supply management unit being operable to read the power supplied to said light source from said light source controller, to search the lookup table to obtain a reference one of the threshold voltage values that belongs to a current one of the parameter sets which includes the light source power value corresponding to the power supplied to said light source, to detect a voltage of the battery as the residual capacity of the battery, and to determine whether the voltage of the battery is smaller than the reference one of the threshold voltage values,
when it is determined that the voltage of the battery is smaller than the reference one of the threshold voltage values, said power supply unit being further operable to search the lookup table, to control said light source controller to supply said light source with the power as the light source power value of a next one of the parameter sets that is next to the current one of the parameter sets in the descending order, and to control said image processing unit to process the input image signal according to the display parameter of the next one of parameter sets.

6. The portable projector device as claimed in claim 5, wherein, when it is determined that the voltage of the battery is smaller than the reference one of the threshold voltage valises of the current one of the parameter sets, said power supply management unit is operable to output a warning signal if the reference one of the threshold voltage values is not greater than a critical one of the threshold voltage values in the descending order in the lookup table, and to turn off said portable projector device if the reference one of the threshold voltage values is the last one of the threshold voltage values in the descending order in the lookup table.

7. The portable projector device as claimed in claim 5, wherein the display parameter of each of the parameter sets in the lookup table is one of a dynamic contrast parameter and a gamma value.

8. A method of prolonging battery life of a battery of a portable projector device and optimising quality of an image projected by the portable projector device, the method to be implemented, by the portable projector device that includes an image processing unit for processing and converting an input image signal according to a display parameter so as to output an output image signal, an optical mechanical system including a light source and an image projecting unit for modulating the light source so as to project an image according to the output image signal, a light source controller for controlling a power supplied to the light source, and a power supply management unit, the method comprising the following steps of:
configuring the power supply management unit to detect a residual capacity of the battery; and
configuring the power supply management unit to enable the light source controller to adjust the power supplied to the light source according to the residual capacity of the battery, and to enable the image processing unit to process the input image signal according to a display parameter related to the residual capacity of the battery so as to optimise the quality of the image projected by she image projecting unit.

9. The method as claimed in claim 8, the power supply management unit storing a lookup table having a plurality of parameter sets, each of which includes a threshold voltage value, a light source power value, and a display parameter, the parameter sets being arranged in the lookup table in a descending order with respect to the respective threshold voltage values,
wherein the power supply management unit is configured to
detect a voltage of the battery as the residual capacity of the battery,
compare the voltage of the battery detected thereby to the threshold voltage values in the descending order in the lookup table,
determine whether the voltage of the battery is greater than one of the threshold voltage values that is approximate to the voltage of the battery, and
when the voltage of the battery is greater than said one of the threshold voltage values, search the lookup table, control the light source controller to supply the light source with the power as the light source power value of a corresponding one of the parameter sets that includes said one of the threshold voltage values, and control the image processing unit to process the input image signal according to the display parameter of the corresponding one of the parameter sets;
said one of the threshold voltage values serving as an applied one of the threshold voltage values.

10. The method as claimed in claim 9, wherein, when it is determined that the voltage of the battery detected by the power supply management unit is smaller than the applied one of the threshold voltage values, the power supply management unit is configured to output, a warning signal if the applied one of the threshold voltage values is not greater than a critical one of the threshold voltage values in the descending order in the lookup table, and to turn off the portable projector device if the applied one of the threshold voltage values is the last one of the threshold voltage values in the descending order in the lookup table.

11. The method as claimed in claim 9, wherein the display parameter of each of the parameter sets in the lookup fable is one of a dynamic contrast parameter and a gamma value.

12. The method as claimed in claim 8, the power supply management unit storing a lookup table having a plurality of parameter sets, each of which includes a threshold voltage value, a light source power value, and a display parameter, the parameter sets being arranged in the lookup table in a descending order with respect to the respective threshold voltage values,
wherein the power supply management unit is configured to
a) read the power supplied to the light source from the light source controller,
b) search the lookup table to obtain a reference one of the threshold voltage values that belongs to a current one of the parameter sets which includes the light source power value corresponding to the power supplied to the light source,
c) detect a voltage of the battery,
d) determine whether the voltage of the battery is smaller than the reference one of the threshold voltage values,
e) when it is determined that the voltage of the battery is smaller than the reference one of the threshold voltage values, search the lookup table, control the light source controller to supply the light source with the power as the light source power value of a next one of the parameter sets that is next to the current one of the parameter sets, and control the image processing unit to process the input image signal according to the display parameter of the next one of the parameter sets, and
f) repeat steps c) to e) with the threshold voltage value of the next one of the parameter sets serving as the reference one of the voltage threshold values, and the next one of the parameter sets serving as the current one of the parameter sets, until the reference one of the threshold voltage values is the last one of the threshold voltage values in the descending order.

13. The method as claimed in claim 12, wherein, when it is determined that the voltage of the battery is smaller than the reference one of the threshold voltage values, the power supply management unit is configured to output a warning signal if the reference one of the threshold voltage values is not greater than a critical one of the threshold voltage values in the descending order in the lookup table, and to turn off the portable projector device if the reference one of the threshold voltage values is the last one of the threshold voltage values in the descending order in the lookup table.

14. The method as claimed in claim 13, wherein the display parameter of each of the parameter sets in the lookup table is one of a dynamic contrast parameter and a gamma value.
